(19) United States
(12) Patent Application Publication
(10) Pub. No.: US 2026/0148231 A1
(43) Pub. Date: May 28, 2026

(54) Systems and Methods for Authorizing Agentic Applications

(71) Applicant: Cisco Technology, Inc., San Jose, CA (US)

(72) Inventors: Hendrikus G. P. Bosch, Amstelveen (NL); Alessandro Duminuco, Milano (IT); Jeffrey M. Napper, Delft (NL)

(21) Appl. No.: 19/257,067

(22) Filed: Jul. 1, 2025

Related U.S. Application Data
(60) Provisional application No. 63/723,785, filed on Nov. 22, 2024.

(51) Int. Cl. G06Q 20/40; G06Q 20/38

(52) U.S. Cl. CPC G06Q 20/401; G06Q 20/3825

(57) ABSTRACT

In an embodiment, a method includes intercepting, by a trust processor, a transaction interaction communicated between an artificial intelligence (AI) agent and a service. The transaction interaction includes a series of requests associated with a transaction. The method also includes receiving, by the trust processor and from a user device, a first response to a request for the user device to provide a verification to a commitment to the transaction. The method further includes determining, by the trust processor, whether to allow the transaction to proceed to the service based on the first response.

### RELATED APPLICATIONS

This application claims priority to U.S. Provisional Patent Application No. 63/723,785, filed Nov. 22, 2024, which is hereby incorporated by reference in its entirety.

### TECHNICAL FIELD

The present disclosure relates generally to communication networks, and more particularly, to systems and methods for authorizing agentic applications.

### BACKGROUND

The advent of generative artificial intelligence (AI) provides for some natural language interaction with applications. For example, people may interact with applications in natural language to complete interactions. However, due to the probabilistic nature of natural language models (LLMs), these interactions are significantly much less reliable than those with a human. In current systems, the lack of reliability requires a human-in-the-loop to verify what a software agent is going to do before action is taken. Current authorization mechanisms typically delegate authority based on a role or generic action to humans.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 illustrates a system for authorizing agentic applications, in accordance with certain embodiments;

FIG. 2A illustrates an operational flow for authorizing agentic applications using a trust processor as a proxy, according to one or more embodiments of the present disclosure;

FIG. 2B illustrates an operational flow for authorizing agentic applications using a trust processor as a service, according to one or more embodiments;

FIG. 3 illustrates a method for authorizing agentic applications, according to one or more embodiments; and

FIG. 4 illustrates a computer system configured to perform the method of FIG. 3, in accordance with certain embodiments.

### DESCRIPTION OF EXAMPLE EMBODIMENTS

### Overview

According to an embodiment, a method includes intercepting, by a trust processor, a transaction interaction communicated between an artificial intelligence (AI) agent and a service. The transaction interaction includes a series of requests associated with a transaction. The method also includes receiving, by the trust processor and from a user device, a first response to a request for the user device to provide a verification to a commitment to the transaction. The method further includes determining, by the trust processor, whether to allow the transaction to proceed to the service based on the first response.

In certain embodiments, the method includes, when the first response verifies the commitment to the transaction: communicating, by the trust processor, the commitment to the transaction to the service, receiving, by the trust processor, a second response from the service, wherein the second response indicates that the service committed the transaction, and/or communicating, by the trust processor, the second response to the user device.

In some embodiments, the method includes signing, by the trust processor, the transaction and communicating, by the trust processor and along with the second response, the signed transaction, a timestamp associated with the transaction, and an established contract associated with the transaction directly to the user device via a secure communication channel.

In certain embodiments, the method includes, when the first response fails to verify the commitment to the transaction: preventing, by the trust processor, the transaction from proceeding to the service, or aborting, by the trust processor, the transaction.

In some embodiments, the method includes communicating, by the trust processor and directly to the user device, the request for the user device to provide the verification of the transaction, wherein the AI agent is unaware of the trust processor.

In certain embodiments, the AI agent communicates the request for the user device to provide the verification of the transaction to the user device. In some embodiments, the AI agent is aware of the trust processor. In certain embodiments, the AI agent is prevented from communicating directly with the service.

According to another embodiment, one or more computer-readable non-transitory storage media embody instructions that, when executed by a processor, cause the processor to perform operations. The operations include intercepting, by a trust processor, a transaction interaction communicated between an AI agent and a service. The transaction interaction includes a series of requests associated with a transaction. The operations also include receiving, by the trust processor and from a user device, a first response to a request for the user device to provide a verification to a commitment to the transaction. The operations further include determining, by the trust processor, whether to allow the transaction to proceed to the service based on the first response.

According to yet another embodiment, a trust processor performs operations including intercepting a transaction interaction communicated between an AI agent and a service. The transaction interaction includes a series of requests associated with a transaction. The operations also include receiving, from a user device, a first response to a request for the user device to provide a verification to a commitment to the transaction. The operations further include determining whether to allow the transaction to proceed to the service based on the first response.

Technical advantages of certain embodiments of this disclosure may include one or more of the following. To enforce trust for AI agents, certain embodiments delegate the trust to a new third party, the trust processor. Similar to a payment processor for financial transactions, the trust Processor executes the transaction on behalf of the human given the AI agent's input and after human verification. By delegating the trust to a third party, the human user does not need to trust the potentially probabilistic AI agent, and many agents can use the same trust system. The trust processor may be a proxy for service(s) that is transparent to the AI agent, or the trust processor and the AI agent may work together to assist the user.

Other technical advantages will be readily apparent to one skilled in the art from the following figures, descriptions, and claims. Moreover, while specific advantages have been enumerated above, various embodiments may include all, some, or none of the enumerated advantages.

### Example Embodiments

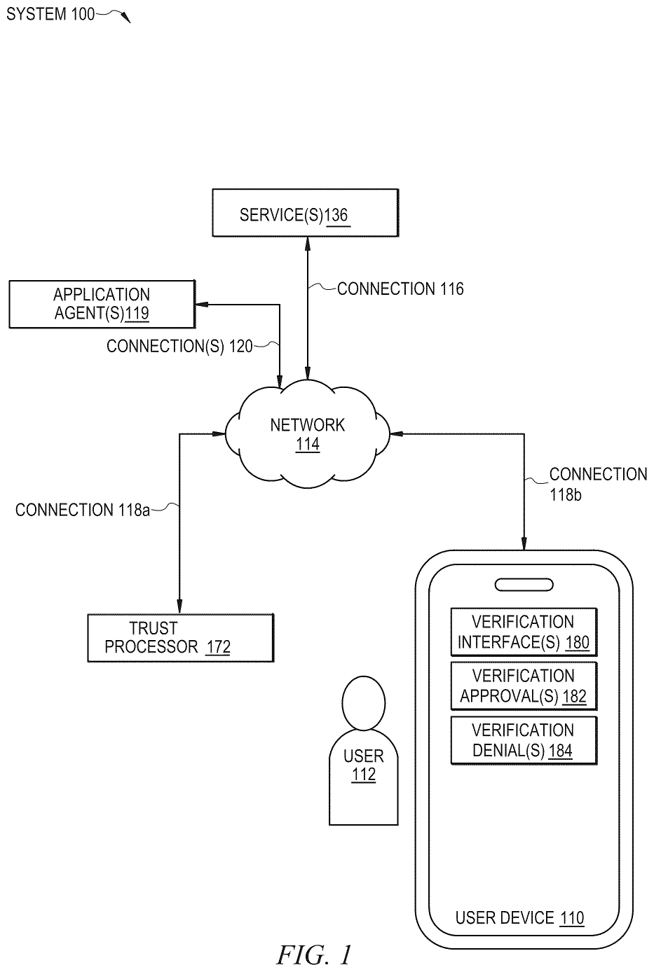

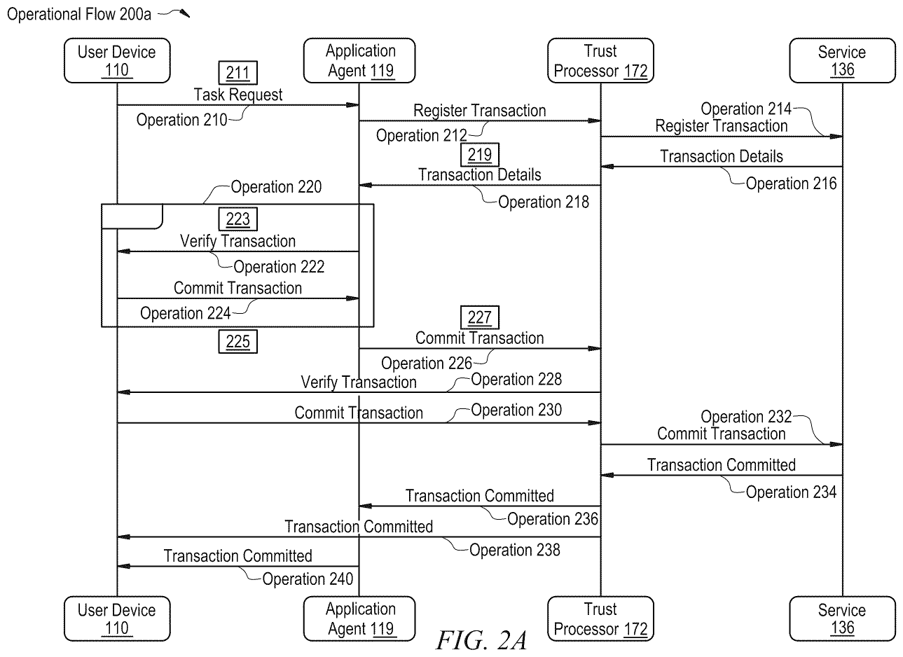

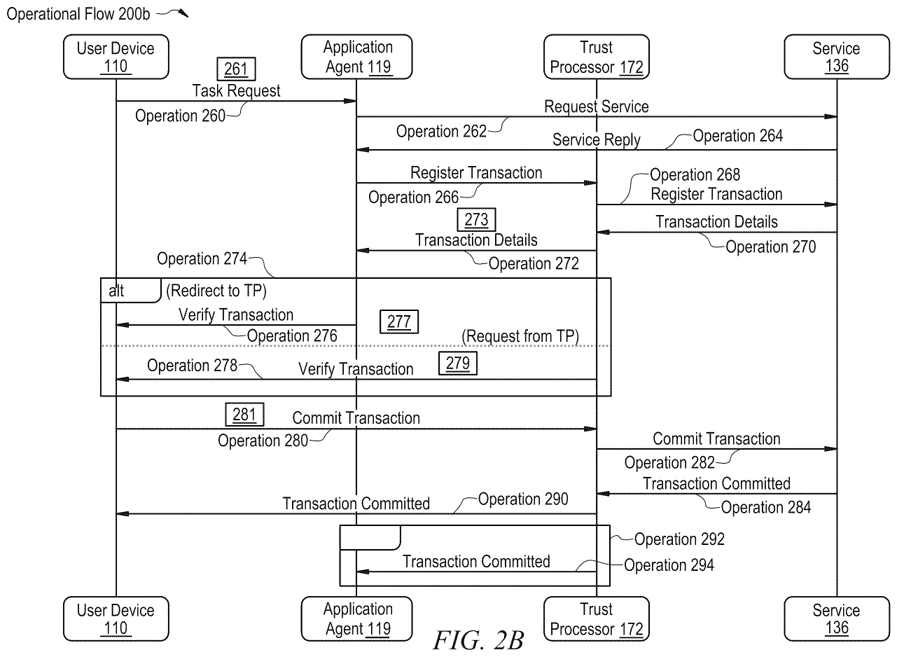

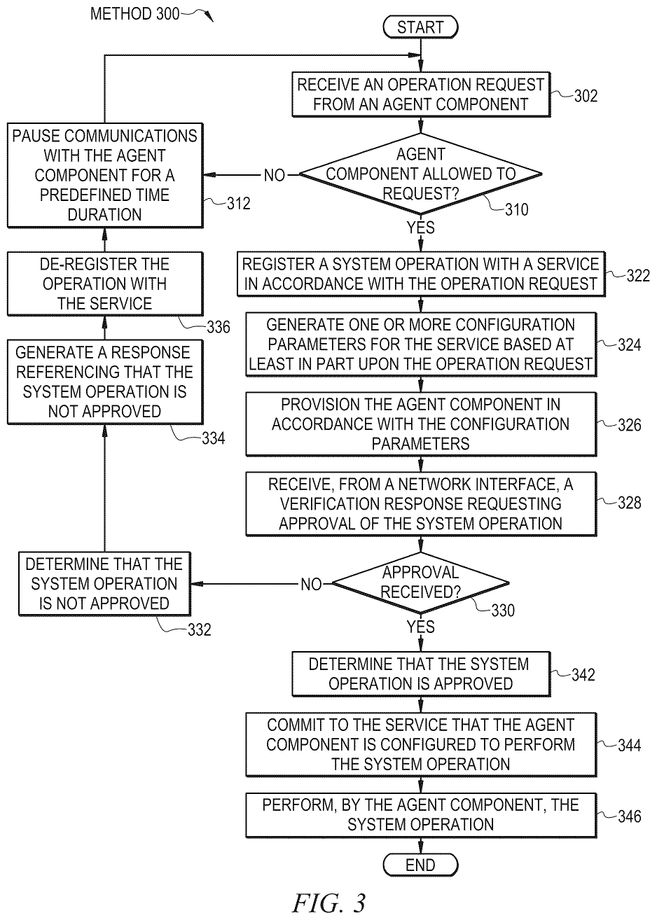

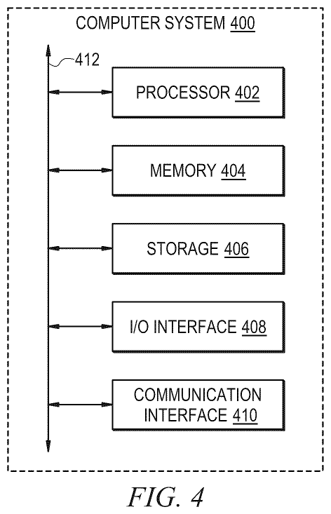

This disclosure describes systems and methods to authorize agentic applications. FIG. 1 illustrates a system 100 for authorizing agentic applications. FIGS. 2A and 2B illustrate operational flows 200a and 200b performed by the system 100 in FIG. 1. FIG. 3 illustrates a method 300 for authorizing agentic applications, and FIG. 4 illustrates a computer system 400 that may be used to perform one or more operations described in reference to FIGS. 1-3.

FIG. 1 illustrates an example system 100 for authorizing agentic applications. System 100 or portions thereof may be associated with an entity, which may include any entity, such as a business, company, or enterprise, which generates risk scores. In certain embodiments, the entity may be a service provider that provides security services. The components of system 100 may include any suitable combination of hardware, firmware, and software. For example, the components of system 100 may use one or more elements of the computer system of FIG. 4.

In the illustrated embodiment of FIG. 1, system 100 includes a user device 110, a user 112, a network 114, one or more application agents 119, one or more services 136, and a trust processor 172. The service 136 is shown communicatively connected to the network 114 via a connection 116. The user device 110 is shown communicatively connected to the network 114 via the connections 118 (shown as the connection 118a for the user device 110a and a connection 118b for the user device 110b). The application agents 119 are shown communicatively connected to the network 114 via the connections 120.

The user device 110 of system 100 represents any electronic equipment configured to receive, create, process, store, and/or communicate information. The user device 110 may include one or more portable devices (e.g., mobile phones (e.g., smartphones), laptop computers, tablets, personal digital assistants (PDAs), tablets, wearable devices, and the like), vehicular communication systems, and the like. In certain embodiments, the user device 110 include an electronic display screen. For example, the user device 110 may include a liquid crystal display (LCD), an organic light-emitting diode (OLED) flat screen interface, digital buttons, a digital keyboard, physical buttons, a physical keyboard, one or more touch screen components, a graphical user interface (GUI), and the like. The user device 110 may be located in any suitable location to receive and communicate information to user 112 of system 100.

The user device 110 of system 100 runs one or more applications. Applications are computer software that perform specific functions for user 112 or for another application. Each application may be self-contained or may be a group of programs. In the illustrated embodiment of FIG. 1, the applications running on user device 110 include device applications.

The user 112 of system 100 represents a person who utilizes user device 110. User 112 may be a local user, a remote user, a programmer, an administrator, a customer, a company, a combination thereof, and the like. In certain embodiments, user 112 is associated with one or more accounts. User 112 may be associated with an account name, a username, a login name, a screen name, one or more passwords, a user profile, and the like. In certain embodiments, user 112 utilizes one or more applications downloaded to user device 110.

Network 114 of system 100 is any type of network that facilitates communication between components of system 100. Network 114 may connect one or more components of system 100. One or more portions of network 114 may include an ad-hoc network, the Internet, an intranet, an extranet, a portion of a Public Switched Telephone Network (PSTN), a virtual private network (VPN), an Ethernet VPN (EVPN), a local area network (LAN), a wireless LAN (WLAN), a virtual LAN (VLAN), a wide area network (WAN), a wireless WAN (WWAN), a software-defined wide area network (SD-WAN), a metropolitan area network (MAN), a cellular telephone network, a Digital Subscriber Line (DSL), an Multiprotocol Label Switching (MPLS) network, a 3G/4G/5G/6G network, a Long Term Evolution (LTE) network, a cloud network, a combination of two or more of these, or other suitable types of networks. Network 114 may include one or more different types of networks. Network 114 may be any communications network, such as a private network, a public network, a connection through the Internet, a mobile network, a Wi-Fi network, and the like. Network 114 may include a core network, an access network of a service provider, an Internet service provider (ISP) network, and the like. One or more components of system 100 may communicate over network 114.

Network 114 may include one or more nodes. Nodes may be connection points within network 114 that receive, create, store and/or send data along a path. Nodes may include one or more redistribution points that recognize, process, and forward data to other nodes of network 114. Nodes may include virtual and/or physical nodes. For example, nodes may include one or more physical devices, virtual machines, bare metal servers, and the like. As another example, nodes may include data communications equipment such as computers, routers, servers, printers, workstations, switches, bridges, modems, hubs, and the like.

The application agents 119 of system 100 represent autonomous software entities. In certain embodiments, application agents 119 are AI agents that generate content (e.g., data, data programs, instructions, operational flows, and the like), make decisions, and/or interact with surrounding physical and/or virtual environments to complete specific tasks. The application agents 119 may interact with one or more physical and/or virtual environments via one or more peripherals and/or interfaces. The application agents 119 may adapt and learn from new data and/or information, offering flexibility and handling complex tasks without and/or with less human intervention.

In some embodiments, the application agents 119 include one or more reflective agents that analyze previous agentic actions and/or decisions, adapt based on feedback summarized from the analyses, and perform one or more updated operations to improve over time. The application agents 119 may be one or more tool agents that continuously monitor agentic performance against predefined target performance parameters. Certain application agents 119 may determine areas in which agentic operations may be deficient, determine one or more solutions to inhibit, solve, and/or eliminate any determined deficiencies, and/or update one or more configuration parameters in accordance with the one or more solutions. The application agents 119 may invoke one or more tools to perform one or more tasks. In one or more embodiments, the application agents 119 are model-based reflex agents that use one or more internal models of the environment to make decisions.

The services 136 of system 100 represent actions or activities performed for the benefit of the user 112. In certain embodiments, services 136 are used to perform transactions. A transaction represents any exchange between two or more parties, where something of value is exchanged for something else of value. In the context of goods and services, one party (e.g., service 136) provides something (goods or services), and receives payment (e.g., from user 112) in return.

The trust processor 172 of system 100 represents a software system designed to manage and/or automate tasks related to trusts. In certain embodiments, trust processor 172 manages and/or automates task for financial institutions. For example, the trust processor 172 may act similar to a payment processor for financial transactions. In certain embodiments, the trust processor 172 executes the transaction on behalf of the human given input from application agent 119 and after human verification. By delegating the trust to the trust processor 172 (e.g., third party), the user 112 does not need to trust the application agent 119, and many application agents 119 can use the same trust system. In certain embodiments, the trust processor 172 is a proxy for the service(s) 136 that is transparent to the application agent 119. In some embodiments, the trust processor 172 and the application agent 119 work together to assist the user 112.

In operation, the trust processor 172 intercepts a transaction interaction communicated between the application agent 119 and the service 136. The transaction interaction includes a series of requests associated with a transaction. If the application agent 119 is unaware of the trust processor 172, then the trust processor 172 communicates a request for verification of the transaction directly to the user device. If the application agent 119 is aware of the transaction, then the AI agent may communicate the request for verification of the transaction the user device 110. The trust processor 172 then receives, from the user device 110, a response to the request for the user device 110 to provide a verification to a commitment to the transaction. The trust processor 172 determines whether to allow the transaction to proceed to the service 136 based on the response. If the trust processor 172 determines to allow the transaction to proceed to the service 136, the trust processor 172 communicates the commitment to the transaction to the service 136. The trust processor 172 then receives a response from the service 136 indicating that the service 136 committed the transaction. The trust processor 172 signs the transaction and communicates the response received from the service 136, the signed transaction, a timestamp associated with the transaction, and an established contract associated with the transaction to the user device 110. If the response received from the user device 110 fails to verify the commitment to the transaction, the trust processor 172 prevents the transaction from proceeding to the service and/or aborts the transaction. As such, the trust processor 172 executes the transaction on behalf of the user 112 given the input from the application agent 119 and after human verification. By delegating the trust to a third party, the user 112 does not need to trust the potentially probabilistic application agent 119, and many application agents 119 can use the same trust system. The trust processor 172 may be a proxy for service(s) that is transparent to the AI agent, or the trust processor 172 and the AI agent may work together to assist the user.

FIG. 2A illustrates an operational flow 200a for authorizing agentic applications using a trust processor 172 as a proxy, in accordance with certain embodiments. The operational flow 200a is performed using the user device 110a (e.g., representative of the user devices 110), an application agent 119 (e.g., an AI application agent), a trust processor 172, and a service 136. In the illustrated embodiment of FIG. 2A, the application agent 119 does not need to be aware of the trust processor 172. The trust processor 172 acts as a proxy for the service 136 with which the application agent 119 interacts. There are many different mechanisms for introducing proxies (e.g., Domain Name System (DNS) redirection). Herein, whenever the application agent 119 interacts with the service 136, the trust processor 172 intercepts and proxies one or more requests.

At operation 210, the user device 110a generates and transfers a task request (e.g., an operation request 211) to application agent 119. In some embodiments, the application agent 119 does not need any credentials to the service 136 as the trust processor 172 communicates directly with the service 136. The application agent 119 may be configured with a different set of credentials that allows the application agent 119 to be identified to the trust processor 172 instead of the service 136. The application agent 119 may be configured with no (or false) credentials, providing it with zero trust.

At operation 212, the application agent 119 registers at least one communication operation (e.g., a data exchange operation and/or transaction) with the trust processor 172. Herein, the trust processor 172 determines one or more previous operations and/or generative operational flows implemented, executed, and/or performed by the specific application agent 119 and evaluate one or more operations of the application agent 119 that lead to the attempt to register a transaction with a service 136. At operation 214, the trust processor 172 registers the transaction with the service 136 if the trust processor 172 approves that the application agent 119 is allowed to interact with the service 136.

At operation 216, the service 136 accepts the registered transaction and provides one or more transaction details to the trust processor 172. At operation 218, the trust processor 172 parses the transaction details and forwards the transaction details 219 for the service 136 to the application agent 119. At operation 220, the application agent 119 and the user device 110a perform operations 222 and 224. At operation 222, the application agent 119 informs (e.g., via a verification request 223) the user device 110a that the trust processor 172 approves of one or more communication operations including the service 136. For example, the application agent 119 may verify the transaction with the user device 110a. The verification is not considered enough for the user device 110a to fully trust the application agent 119. If a request is determined to be a transaction commit (e.g., to submit a particular form in a web application), the user device 110a may request one or more communication operations directly by the trust processor 172 to verify that the user device 110a is allowed to perform one or more of the communication operations.

At operation 224, the user device 110a commits (e.g., via a verification response 225) to the application agent 119 that the user device 110a accepts performing the communication operations. At operation 226, the application agent 119 informs (e.g., via a verification response 127) the trust processor 172 that the application agent 119 is accepted to perform one or more communication operations including the service 136.

At operation 228, the trust processor 172 verifies whether the user device 110a approved the communication operations by double-checking information with the user device 110a. In the event the user device 110a cancels the communication operations and/or one or more errors occur, the trust processor 172 prevents the transaction commit or inhibits, stop, and/or cancels one or more of the communication operations (e.g., cancel a form submission).

At operation 230, the trust processor 172 receives from the user device 110a that the communication operations are approved by the user device 110a. At operation 232, the trust processor 172 informs the service 136 that the communication operations are allowed to be performed between the application agent 119, the user device 110a, and the service 136.

At operation 234, the service 136 confirms with the trust processor 172 that the transaction has been committed. At operation 236, the application agent 119 receives a confirmation that transaction has been committed. At operation 238, the trust processor 172 provides the confirmation that communication operations are expected to be performed. Since the trust processor 172 may proxy a service interaction, the trust processor 172 may provide one or more relevant details to the user device 110a (e.g., the complete content of a form submission). In some embodiments, the trust processor 172 provides one or more evaluation results of a committed transaction to the application agent 119 and the user device 110a. The trust processor 172 is commits to the service 136 by initiating the application agent 119 to perform the system operation. At operation 240, the application agent 119 performs the one or more communication operations with the user device 110a.

In the example of FIG. 2A, the trust processor 172 enforces trust of the application agent 119 over time. The trust processor 172 may execute one or more communication operations on behalf of a user device 110a given an input to the application agent 119 and after user device verification between the user device 110a and the trust processor 172. By delegating the trust to the trust processor 172, the user device 110a does not rely on its internal tracking of the application agent 119 to trust any probabilistic application agents. FIG. 2A shows an example in which the trust processor 172 is a proxy for the service 136 that is transparent to the AI agent.

In one or more embodiments, the trust processor 172 is capable of signing the transaction for non-repudiation purposes. The trust processor 172 may be equipped with key material through which the user device 110a attests whether a transaction took place by a trust processor 172, on a certain date and time of day, contract that is been established, and/or a precise response as received from the service 136. The trust processor 172 may run in a secure enclave or include a connection to a secure enclave for signing purposes to keep key material private and/or at one or more levels of security. If the application agent 119 cannot be trusted, the trust processor 172 may include a direct connection with the user device 110a for recording an agreement triggering the one or more communication operations. The communication operations may include recording server details associated with authenticated material for one or more non-repudiation requirements and/or conditions.

Although FIG. 2A illustrates a particular number of components of the operational flow 200a, this disclosure contemplates any suitable number of components. Although FIG. 2A illustrates a particular arrangement of the components of the operational flow 200a, this disclosure contemplates any suitable arrangement of the components. Furthermore, although FIG. 2A describes and illustrates particular components, devices, or systems performing particular actions, this disclosure contemplates any suitable combination of any suitable components, devices, or systems performing any suitable actions.

FIG. 2B illustrates an operational flow 200b for authorizing agentic applications using a trust processor 172 as a service, according to one or more embodiments. The operational flow 200b is performed using the user device 110a (e.g., representative of the user devices 110), an application agent 119, a trust processor 172, and a service 136. Herein, the trust processor 172 may verify system operations to be performed by the application agent 119 by verifying system operations with the user device 110a and without verifying with the application agent 119. In FIG. 2B, the trust processor 172 acts as an explicit service provider between the application agent 119, the user device 110a, and the service 136.

At operation 260, the user device 110a generates and transfer a task request (e.g., an operation request 261) to an application agent 119. At operation 262, the application agent 119 sends a request to the service 136.

At operation 264, the service 136 sends a reply to the application agent 119 acknowledging that the service 136 received the request. At operation 266, the application agent 119 registers the transaction with the trust processor 172. At operation 268, the trust processor 172 registers the transaction with the service 136.

At operation 270, the service 136 communicates one or more transaction details to the trust processor 172. At operation 272, the trust processor 172 parses the transaction details and forwards the transaction details 273 for the service 136 to the application agent 119. At operation 274, the application agent 119 and the user device 110a perform operation 276 or 278.

At operation 276 and at operation 278, the application agent 119 and/or the trust processor 172 inform (e.g., via a verification request 277 and verification request 279, respectively) the user device 110a that the trust processor 172 approves of one or more communication operations including the service 136. At operation 280, the user device 110a sends a notification to the trust processor 172 committing (via commit transaction 281) to the transaction. At operation 282, the trust processor 172 communicates commit transaction 281 to the service 136.

At operation 284, the service 136 commits the transaction and communicates a confirmation of the committed transaction to the trust processor 172. At operation 290, the trust processor 172 provides the confirmation to the user device 110a. At operation 292, the trust processor 172 may also provide the confirmation to the application agent 119.

In the example of FIG. 2B, the application agent 119 works with the trust processor 172 to create trust for the user device 110a. In this case, the application agent 119 may limit trust processor 172 interactions with the application agent 119 to operations required to commit a transaction with the service 136. Since the trust processor 172 is aware of the transaction, the messages informing the user device 110a may come from the application agent 119 to redirect the user device 110a to the trust processor 172 or may come directly from the trust processor 172. In either case, the commit messages are provided from the user device 110a to the trust processor 172 directly. The trust processor 172 may commit one or more communication operations with the services 136. In some embodiments, committed transaction details are provided to the user device 110a and optionally to the application agent 119 directly (e.g., if the user device 110a is not originally redirected). Herein, the application agent 119 may not need any credentials to be able to commit a transaction with the services 136. Thus, the application agent 119 may be provided with reduced and/or limited “read-only” (or similar) credentials that allow the AI agent to communicate directly with the service 136.

Although FIG. 2B illustrates a particular number of components of the operational flow 200b, this disclosure contemplates any suitable number of components. Although FIG. 2B illustrates a particular arrangement of the components of the operational flow 200B, this disclosure contemplates any suitable arrangement of the components. Furthermore, although FIG. 2B describes and illustrates particular components, devices, or systems performing particular actions, this disclosure contemplates any suitable combination of any suitable components, devices, or systems performing any suitable actions.

FIG. 3 illustrates a method 300 of orchestrating agent operations, in accordance with certain embodiments. Method 300 may be implemented by one or more components of the system 100 of FIG. 1. The method 300 starts at step 302, where the trust processor (e.g., trust processor 172 of FIG. 1) intercepts a transaction interaction communicated between an artificial intelligence (AI) agent (e.g., application agent 119 of FIG. 1) and a service (e.g., service 136 of FIG. 1). In certain embodiments, the transaction interaction includes a series of requests associated with a transaction.

The AI agent may or may not be aware of the trust processor. If the AI agent is aware of the trust processor, the AI agent communicates a request for to provide a verification of the transaction to the user device. If the AI agent is unaware of the trust processor, then the trust processor communicates the request for the user device to provide the verification of the transaction directly to the user device via a secure communication channel. Method 300 then moves to step 310.

At step 310 of method 300, the trust processor receives a response from the user device indicating whether or not the user has committed to the transaction. Based on the response, the trust processor determines whether to allow the transaction to proceed to the service. If, at step 310, the response received from the user device does not include a commitment to the transaction, method 300 moves to step 312, where the trust processor prevents the transaction from proceeding to the service. In certain embodiments, the trust processor may abort the transaction. Method 300 then ends at step 312.

If, at step 310, the response received from the user device includes a commitment to the transaction, method 300 moves to step 322, where the trust processor communicates the commitment to the transaction to the service. At step 324 of method 300, the trust processor receives a response from the service indicating that the service committed the transaction. At step 326 of method 300, the trust processor signs the transaction. And at step 328 of method 300, the trust processor communicates the response received from the service, the signed transaction, a timestamp associated with the transaction, and/or an established contract associated with the transaction to the user device.

Although this disclosure describes and illustrates particular operations in the method 300 of FIG. 3 as occurring in a particular order, this disclosure contemplates any suitable steps of the method 300 of FIG. 3 occurring in any suitable order. Although this disclosure describes and illustrates an example method of orchestrating agent operations including the particular steps of the method of FIG. 3, this disclosure contemplates any suitable method of orchestrating communication operations, which may include all, some, or none of the steps of the method of FIG. 3, where appropriate. Furthermore, although FIG. 3 describes and illustrates particular components, devices, or systems performing particular actions, this disclosure contemplates any suitable combination of any suitable components, devices, or systems performing any suitable actions.

FIG. 4 illustrates an example computer system 400. In particular embodiments, one or more computer system 400 perform one or more steps of one or more methods described or illustrated herein. In particular embodiments, the one or more computer system 400 provide functionality described or illustrated herein. In particular embodiments, software running the on one or more computer system 400 performs one or more steps of one or more methods described or illustrated herein or provides functionality described or illustrated herein. Particular embodiments include one or more portions of the one or more computer system 400. Herein, reference to a computer system may encompass a computing device, and vice versa, where appropriate. Moreover, reference to a computer system may encompass one or more computer systems, where appropriate.

This disclosure contemplates any suitable number of computer system 400. This disclosure contemplates the computer system 400 taking any suitable physical form. As example and not by way of limitation, the computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 400 may include the one or more computer system 400; be unitary or distributed; span multiple locations; span multiple machines; span multiple data centers; or reside in a cloud, which may include one or more cloud components in one or more networks. Where appropriate, the one or more computer system 400 may perform without substantial spatial or temporal limitation one or more steps of one or more methods described or illustrated herein. As an example, and not by way of limitation, the one or more computer system 400 may perform in real time or in batch mode one or more steps of one or more methods described or illustrated herein. The one or more computer system 400 may perform at different times or at different locations one or more steps of one or more methods described or illustrated herein, where appropriate.

In particular embodiments, the computer system 400 includes a processor 402, a memory 404, a storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 402 includes hardware for executing instructions, such as those making up a computer program. As an example, and not by way of limitation, to execute instructions, the processor 402 may retrieve (or fetch) the instructions from an internal register, an internal cache, the memory 404, or the storage 406; decode and execute them; and then write one or more results to an internal register, an internal cache, the memory 404, or the storage 406. In particular embodiments, the processor 402 may include one or more internal caches for data, instructions, or addresses. This disclosure contemplates the processor 402 including any suitable number of any suitable internal caches, where appropriate. As an example, and not by way of limitation, the processor 402 may include one or more instruction caches, one or more data caches, and one or more translation lookaside buffers (TLBs). Instructions in the instruction caches may be copies of instructions in the memory 404 or the storage 406, and the instruction caches may speed up retrieval of those instructions by the processor 402. Data in the data caches may be copies of data in the memory 404 or the storage 406 for instructions executing at the processor 402 to operate on; the results of previous instructions executed at the processor 402 for access by subsequent instructions executing at the processor 402 or for writing to the memory 404 or the storage 406; or other suitable data. The data caches may speed up read or write operations by the processor 402. The TLBs may speed up virtual-address translation for processor 402. In particular embodiments, processor 402 may include one or more internal registers for data, instructions, or addresses. This disclosure contemplates the processor 402 including any suitable number of any suitable internal registers, where appropriate. Where appropriate, the processor 402 may include one or more arithmetic logic units (ALUs); be a multi-core processor; or include one or more processors 402. Although this disclosure describes and illustrates a particular processor, this disclosure contemplates any suitable processor.

In particular embodiments, the memory 404 includes main memory for storing instructions for the processor 402 to execute or data for the processor 402 to operate on. As an example, and not by way of limitation, the computer system 400 may load instructions from storage 406 or another source (such as, for example, another computer system 400) to the memory 404. The processor 402 may then load the instructions from the memory 404 to an internal register or internal cache. To execute the instructions, the processor 402 may retrieve the instructions from the internal register or internal cache and decode them. During or after execution of the instructions, the processor 402 may write one or more results (which may be intermediate or final results) to the internal register or internal cache. The processor 402 may then write one or more of those results to memory 404. In particular embodiments, the processor 402 executes only instructions in one or more internal registers or internal caches or in the memory 404 (as opposed to the storage 406 or elsewhere) and operates only on data in one or more internal registers or internal caches or in the memory 404 (as opposed to the storage 406 or elsewhere). One or more memory buses (which may each include an address bus and a data bus) may couple the processor 402 to the memory 404. The bus 412 may include one or more memory buses, as described below. In particular embodiments, one or more memory management units (MMUs) reside between the processor 402 and the memory 404 and facilitate accesses to the memory 404 requested by the processor 402. In particular embodiments, the memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. The memory 404 may include one or more memories 404, where appropriate. Although this disclosure describes and illustrates particular memory, this disclosure contemplates any suitable memory.

In particular embodiments, the storage 406 includes mass storage for data or instructions. As an example, and not by way of limitation, the storage 406 may include a hard disk drive (HDD), a floppy disk drive, flash memory, an optical disc, a magneto-optical disc, magnetic tape, or a Universal Serial Bus (USB) drive or a combination of two or more of these. The storage 406 may include removable or non-removable (or fixed) media, where appropriate. The storage 406 may be internal or external to the computer system 400, where appropriate. In particular embodiments, the storage 406 is non-volatile, solid-state memory. In particular embodiments, the storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates a mass storage 406 taking any suitable physical form. The storage 406 may include one or more storage control units facilitating communication between the processor 402 and the storage 406, where appropriate. Where appropriate, the storage 406 may include one or more storages 406. Although this disclosure describes and illustrates particular storage, this disclosure contemplates any suitable storage.

In particular embodiments, the I/O interface 408 includes hardware, software, or both, providing one or more interfaces for communication between the computer system 400 and one or more I/O devices. The computer system 400 may include one or more of these I/O devices, where appropriate. One or more of these I/O devices may enable communication between a person and the computer system 400. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, the I/O interface 408 may include one or more device or software drivers enabling processor 402 to drive one or more of these I/O devices. The I/O interface 408 may include one or more I/O interfaces 408, where appropriate. Although this disclosure describes and illustrates a particular I/O interface, this disclosure contemplates any suitable I/O interface.

In particular embodiments, the communication interface 410 includes hardware, software, or both providing one or more interfaces for communication (such as, for example, packet-based communication) between the computer system 400 and one or more other computer system 400 or one or more networks. As an example, and not by way of limitation, the communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example, and not by way of limitation, the computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. The computer system 400 may include any suitable communication interface 410 for any of these networks, where appropriate. The communication interface 410 may include one or more communication interfaces 410, where appropriate. Although this disclosure describes and illustrates a particular communication interface, this disclosure contemplates any suitable communication interface.

In particular embodiments, the bus 412 includes hardware, software, or both coupling components of the computer system 400 to each other. As an example and not by way of limitation, the bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. The bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein.

Modifications, additions, or omissions may be made to the elements shown in the figures above. The components of a device may be integrated or separated. Moreover, the functionality of a device may be performed by more, fewer, or other components. The components within a device may be communicatively coupled in any suitable manner. Functionality described herein may be performed by one device or distributed across multiple devices. In general, systems and/or components described in this disclosure as performing certain functionality may include non-transitory computer readable memory storing instructions and processing circuitry operable to execute the instructions to cause the system/component to perform the described functionality.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

Any appropriate steps, methods, features, functions, or benefits disclosed herein may be performed through one or more functional units or modules of one or more virtual apparatuses. Each virtual apparatus may include a number of these functional units. These functional units may be implemented via processing circuitry configured to execute program code stored in memory. The term unit may have conventional meaning in the field of electronics, electrical devices and/or electronic devices and may include, for example, electrical and/or electronic circuitry, devices, modules, processors, receivers, transmitters, memories, logic solid state and/or discrete devices, computer programs or instructions for carrying out respective tasks, procedures, computations, outputs, and/or displaying functions, and so on, as such as those that are described herein.

What is claimed is:

1. A method, comprising:
intercepting, by a trust processor, a transaction interaction communicated between an artificial intelligence (AI) agent and a service, wherein the transaction interaction comprises a series of requests associated with a transaction;
receiving, by the trust processor and from a user device, a first response to a request for the user device to provide a verification to a commitment to the transaction; and
determining, by the trust processor, whether to allow the transaction to proceed to the service based on the first response.

2. The method of claim 1, further comprising, when the first response verifies the commitment to the transaction:
communicating, by the trust processor, the commitment to the transaction to the service;
receiving, by the trust processor, a second response from the service, wherein the second response indicates that the service committed the transaction; and
communicating, by the trust processor, the second response to the user device.

3. The method of claim 2, further comprising:
signing, by the trust processor, the transaction; and
communicating, by the trust processor and along with the second response, the signed transaction, a timestamp associated with the transaction, and an established contract associated with the transaction directly to the user device via a secure communication channel.

4. The method of claim 1, further comprising, when the first response fails to verify the commitment to the transaction:
preventing, by the trust processor, the transaction from proceeding to the service; or
aborting, by the trust processor, the transaction.

5. The method of claim 1, further comprising communicating, by the trust processor and directly to the user device, the request for the user device to provide the verification of the transaction, wherein the AI agent is unaware of the trust processor.

6. The method of claim 1, wherein:
the AI agent communicates the request for the user device to provide the verification of the transaction to the user device; and
the AI agent is aware of the trust processor.

7. The method of claim 1, wherein the AI agent is prevented from communicating directly with the service.

8. A non-transitory computer-readable medium storing instructions that, when executed by a processor, cause the processor to perform operations comprising:
intercepting, by a trust processor, a transaction interaction communicated between an artificial intelligence (AI) agent and a service, wherein the transaction interaction comprises a series of requests associated with a transaction;
receiving, by the trust processor and from a user device, a first response to a request for the user device to provide a verification to a commitment to the transaction; and
determining, by the trust processor, whether to allow the transaction to proceed to the service based on the first response.

9. The non-transitory computer-readable medium of claim 8, the operations further comprising, when the first response verifies the commitment to the transaction:
communicating, by the trust processor, the commitment to the transaction to the service;
receiving, by the trust processor, a second response from the service, wherein the second response indicates that the service committed the transaction; and
communicating, by the trust processor, the second response to the user device.

10. The non-transitory computer-readable medium of claim 9, the operations further comprising:
signing, by the trust processor, the transaction; and
communicating, by the trust processor and along with the second response, the signed transaction, a timestamp associated with the transaction, and an established contract associated with the transaction directly to the user device via a secure communication channel.

11. The non-transitory computer-readable medium of claim 8, the operations further comprising, when the first response fails to verify the commitment to the transaction:
preventing, by the trust processor, the transaction from proceeding to the service; or
aborting, by the trust processor, the transaction.

12. The non-transitory computer-readable medium of claim 8, the operations further comprising communicating, by the trust processor and directly to the user device, the request for the user device to provide the verification of the transaction, wherein the AI agent is unaware of the trust processor.

13. The non-transitory computer-readable medium of claim 8, wherein:
the AI agent communicates the request for the user device to provide the verification of the transaction to the user device; and
the AI agent is aware of the trust processor.

14. The non-transitory computer-readable medium of claim 8, wherein the AI agent is prevented from communicating directly with the service.

15. A trust processor, the trust processor performing operations comprising:
intercepting a transaction interaction communicated between an artificial intelligence (AI) agent and a service, wherein the transaction interaction comprises a series of requests associated with a transaction;
receiving, from a user device, a first response to a request for the user device to provide a verification to a commitment to the transaction; and
determining whether to allow the transaction to proceed to the service based on the first response.

16. The trust processor of claim 15, the operations further comprising, when the first response verifies the commitment to the transaction:
communicating, by the trust processor, the commitment to the transaction to the service;
receiving, by the trust processor, a second response from the service, wherein the second response indicates that the service committed the transaction; and
communicating, by the trust processor, the second response to the user device.

17. The trust processor of claim 16, the operations further comprising:
signing, by the trust processor, the transaction; and
communicating, by the trust processor and along with the second response, the signed transaction, a timestamp associated with the transaction, and an established contract associated with the transaction directly to the user device via a secure communication channel.

18. The trust processor of claim 15, the operations further comprising, when the first response fails to verify the commitment to the transaction:
preventing, by the trust processor, the transaction from proceeding to the service; or
aborting, by the trust processor, the transaction.

19. The trust processor of claim 15, the operations further comprising communicating, by the trust processor and directly to the user device, the request for the user device to provide the verification of the transaction, wherein the AI agent is unaware of the trust processor.

20. The trust processor of claim 15, wherein:
the AI agent communicates the request for the user device to provide the verification of the transaction to the user device; and
the AI agent is aware of the trust processor.
